(19) United States
(12) Patent Application Publication
(10) Pub. No.: US 2014/0244977 A1
(43) Pub. Date: Aug. 28, 2014

(54) Deferred Saving of Registers in a Shared Register Pool for a Multithreaded Microprocessor

(71) Applicant: MIPS TECHNOLOGIES, INC., Sunnyvale, CA (US)

(72) Inventor: Ilie GARBACEA, Santa Clara, CA (US)

(73) Assignees: MIPS Technologies, Inc., Sunnyvale, CA (US); Ilie GARBACEA, Santa Clara, CA (US)

(21) Appl. No.: 13/774,140

(22) Filed: Feb. 22, 2013

(51) Int. Cl. G06F 9/30

(52) U.S. Cl. CPC G06F 9/30098
USPC 712/216

(57) ABSTRACT

A method of sharing a plurality of registers in a register pool among a plurality of microprocessor threads begins by allocating a first set of registers in the register pool to a first thread, the first thread executing a first instruction using the first set of registers in the register pool. The first thread is descheduled without saving values stored in the first set of registers. A second thread is scheduled to execute a second instruction using registers allocated in the register pool. Finally, the first thread is rescheduled, the first thread reusing the allocated first set of registers.

### BACKGROUND

1. Field of the Invention

The invention is generally related to microprocessors.

2. Related Art

Conventional microprocessors can be implemented using multithreaded instruction execution to improve the overall performance and efficiency of the microprocessor. Conventional register approaches have registers assigned to each executing thread to support instruction execution.

Some types of instructions, e.g., Single Instruction Multiple Data (SIMD) instructions require very large registers. Generally implemented as hardware features on the surface of the microprocessor, registers take up valuable space. As demand for smaller and more powerful microprocessors increases, space taken up by registers can decrease the efficiency of a microprocessor. This is especially evident with large SIMD registers, the bit-size of these registers requiring larger amounts of space than older, non-SIMD implementations.

Managing context switching with SIMD registers can be challenging. Large amounts of processing can be involved with storing and reloading register values when registers are shared serially with multiple threads.

### BRIEF SUMMARY OF THE INVENTION

An embodiment provides a method of sharing a plurality of registers in a register pool among a plurality of microprocessor threads using deferred register storage. The method begins by allocating a first set of registers in the register pool to a first thread, the first thread executing a first instruction using the first set of registers in the register pool. The first thread is descheduled without saving values stored in the first set of registers. A second thread is scheduled to execute a second instruction using registers allocated in the register pool. Finally, the first thread is rescheduled, the first thread reusing the allocated first set of registers.

A system for sharing a plurality of registers in a shared register pool among a plurality of microprocessor threads is also provided. The system includes a thread processing resource that executes a first microprocessor thread and a register allocator configured to allocate a first set of registers in the register pool to a first thread. The thread processing resource executes a first instruction using the first thread and the first set of registers in the register pool. The system also includes a thread scheduler that deschedules the first thread without saving values stored in the first set of registers and schedules a second thread to execute a second instruction using registers allocated in the register pool. Finally, the thread scheduler reschedules the first thread, the first thread reusing the allocated first set of registers.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention.

FIG. 1 shows a microprocessor having a system for sharing a shared register pool among a plurality of threads, according to an embodiment.

FIG. 2 shows a system including a shared physical register pool, a register mapper, a register allocator and a register storage manager according to an embodiment.

FIG. 3 shows a system for storing registers in a shared physical register pool using a register storage manager, according to an embodiment.

FIG. 4 shows a system for mapping logical registers used by multiple microprocessor threads to a shared physical register pool using a register storage manager, according to an embodiment.

FIG. 5 shows a flowchart illustrating the stages of a method of performing an embodiment.

FIG. 6 shows a diagram of an example microprocessor core for implementing a shared physical register pool, according to an embodiment.

Features and advantages of the invention will become more apparent from the detailed description of embodiments of the invention set forth below when taken in conjunction with the drawings in which like reference characters identify corresponding elements throughout. In the drawings, like reference numbers generally indicate identical, functionally similar, and/or structurally similar elements. The drawings in which an element first appears is indicated by the leftmost digit(s) in the corresponding reference number.

### DETAILED DESCRIPTION

The following detailed description of embodiments of the invention refers to the accompanying drawings that illustrate exemplary embodiments. Embodiments described herein relate to deferred register storage in a shared register pool. Other embodiments are possible, and modifications can be made to the embodiments within the spirit and scope of this description. Therefore, the detailed description is not meant to limit the embodiments described below.

It should be apparent to one of skill in the relevant art that the embodiments described below can be implemented in many different embodiments of software, hardware, firmware, and/or the entities illustrated in the figures. Any actual software code with the specialized control of hardware to implement embodiments is not limiting of this description. Thus, the operational behavior of embodiments will be described with the understanding that modifications and variations of the embodiments are possible, given the level of detail presented herein.

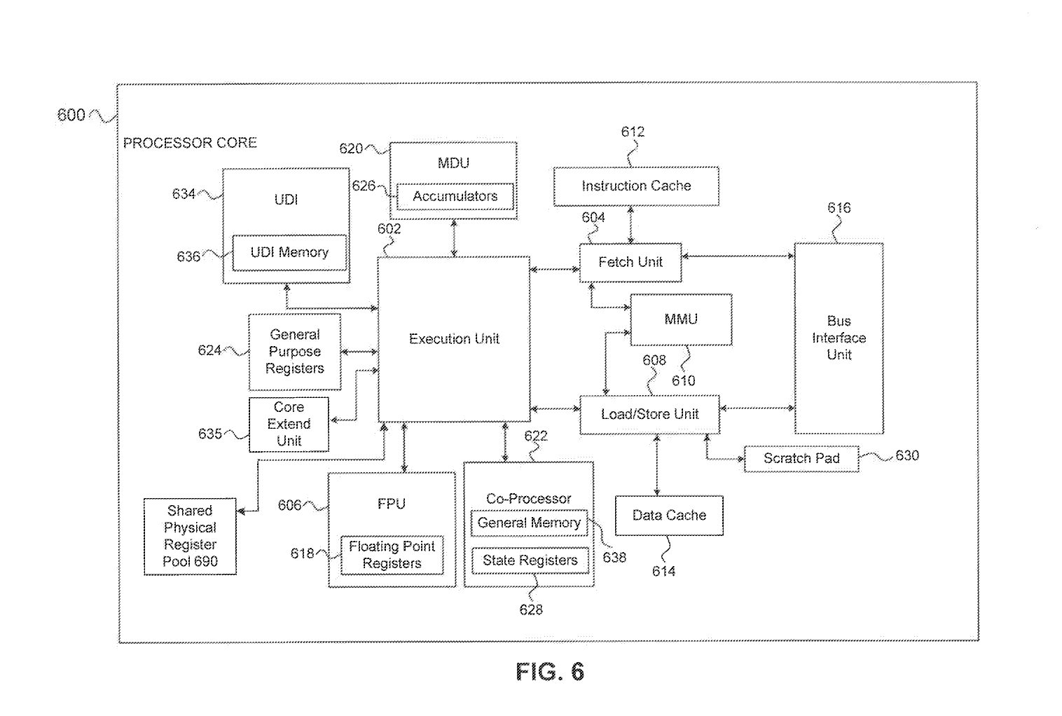

It will be appreciated that software embodiments may be implemented or facilitated by or in cooperation with hardware components enabling the functionality of the various software routines, modules, elements, or instructions. Example hardware components are described further with respect to FIG. 6 below, e.g., processor core 600 that includes an execution unit 602, a fetch unit 604, a floating point unit 606, a load/store unit 608, a memory management unit (MMU) 610, an instruction cache 612, a data cache 614, a bus interface unit 616, a multiply/divide unit (MDU) 620, a co-processor 622, general purpose registers 624, a scratch pad 630, shared physical register pool 690 and a core extend unit 635.

### Shared Register Pool Operation

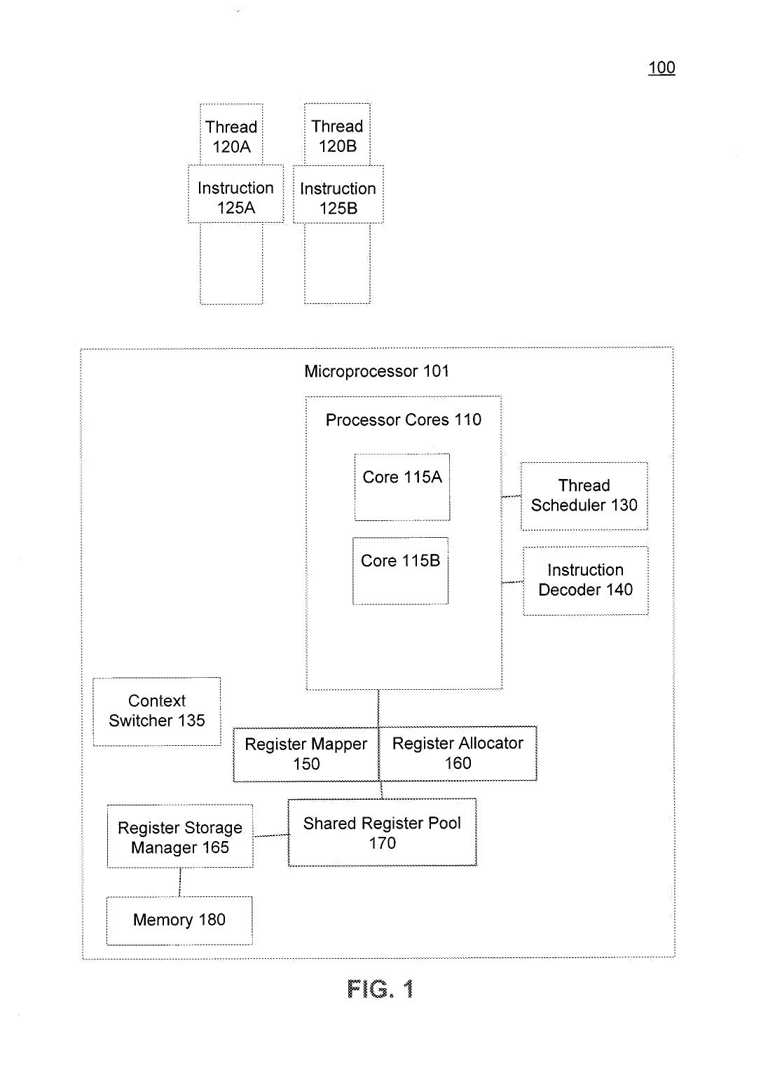

FIG. 1 shows a system 100 with a microprocessor 101 for sharing a shared register pool 170 among a plurality of microprocessor threads 120A-B, according to an embodiment. Microprocessor 101 has processor cores 110, thread scheduler 130, instruction decoder 140, context switcher 135, register mapper 150, register allocator 160, register storage manager 165, memory 180 and shared register pool 170. Processor cores 115A-B respectively execute instructions 125A-B in respective threads 120A-B. An example of the operation of an embodiment is described below.

It should be noted that, as used herein, scheduling and descheduling would be appreciated by one having skill in the relevant art(s). Threads are scheduled when the thread is selected to be executed by a microprocessor core. For example, thread 120A can be scheduled to be executed by microprocessor core 100. As used herein, a scheduled thread can also be a thread that is currently being executed by a microprocessor core. A descheduled thread is a tread that has been selected to stop being executed.

### Non-Deferred Register Storage

This example describes an approach to using a shared register pool that does not defer register storage. Generally speaking, in this approach, storing register values in a register pool shared among threads upon context switches is not deferred.

In this example, using shared register pool 170, threads 120A-B are serially executed by core 115A. Upon commencing the execution of instruction 125A by thread 120A, register allocator 160 allocates physical registers in shared register pool 170 and register mapper 150 generates new mappings to connect the logical registers referenced by thread 120A to the allocated physical registers in shared register pool 170.

By conventional multithreading principles, when thread 120A is descheduled in core 115A, the values stored in all of the registers referenced by thread 120A are deallocated and temporarily stored in memory 180. When thread 120B is scheduled in core 115A, its register values are stored in registers newly allocated by register allocator 160. Upon rescheduling of thread 120A, the stored register values are reloaded from memory 180 into shared register pool 170. This storage and retrieval of register values associated with threads is a part of thread context switching for threads 120A-B.

In embodiments of shared register pool 170, when the register values of thread 120A are reloaded from memory 180 into shared register pool 170, if another thread (not shown) is also using shared register pool 170 registers while being executed by core 115B, register allocator 160 can direct the reloading of register values stored in memory 180 into physical registers in shared register pool 170 that are not used by the other executing thread. Register mapper 150 generates mappings to connect the logical registers referenced by the rescheduled thread 120A to the new allocated physical registers provided by register allocator 160.

In this example, the above-described storage of register values in memory 180 occurs for allocated registers of threads 120A upon the descheduling of thread 120A. All allocated registers for thread 120A are stored in memory 180 at the time of descheduling, i.e., the deallocation and storage is not deferred until a later time. This storage and preparation for a newly scheduled thread is handled by context switcher 135.

### Deferred Register Storage

In an embodiment, in contrast to the non-deferred register storage described above, registers allocated to thread 120A in shared register pool 170 are not stored in memory 180 at time thread 120A is descheduled. Upon descheduling, as described further below, instead of immediate storage of register values associated with thread 120A, the described storage is either deferred or not performed at all. In an embodiment, the associated registers are still deallocated (in that they are not actively being used by thread 120A), but the values associated with thread 120A stored in associated registers are maintained in the respective registers. Reuse of these register values is described further below.

In an example that illustrates an approach to deferred register storage, using shared register pool 170 described above, threads 120A-B are serially executed by core 115A. Upon commencing the execution of instruction 125A by thread 120A, register allocator 160 allocates physical registers in shared register pool 170 and register mapper 150 generates new mappings to connect the logical registers referenced by thread 120A to the allocated physical registers in shared register pool 170.

Unlike the non-deferred register storage above, in an embodiment, when thread 120A is descheduled in core 115A, register storage manager 165 manages the potential storage of register values associated with thread 120A in memory 180. In this example, based on this management by register storage manager 165, none of the values stored in the registers referenced by thread 120A are temporarily stored in memory 180. The registers allocated to thread 120A are deallocated, but register mapper 150 maintains the mappings associated with thread 120A, and the values stored in shared register pool 170 are maintained. Register storage manager 165 maintains a record of the status of the registers in shared register pool 170, and which values have been maintained for each thread.

When thread 120B is initially scheduled in core 115A, its register values are stored in registers newly allocated by register allocator 160. Register allocator 160 can allocate registers in shared register pool 170 based on the registers allocated to thread 120A. Thus, if at all possible, the registers allocated to thread 120A will not be allocated to thread 120B—though if needed, the allocation could be performed. In this example, registers not allocated to thread 120A are allocated to thread 120B, and register mapper 150 maps the newly allocated physical registers in shared register pool 170 to thread 120B.

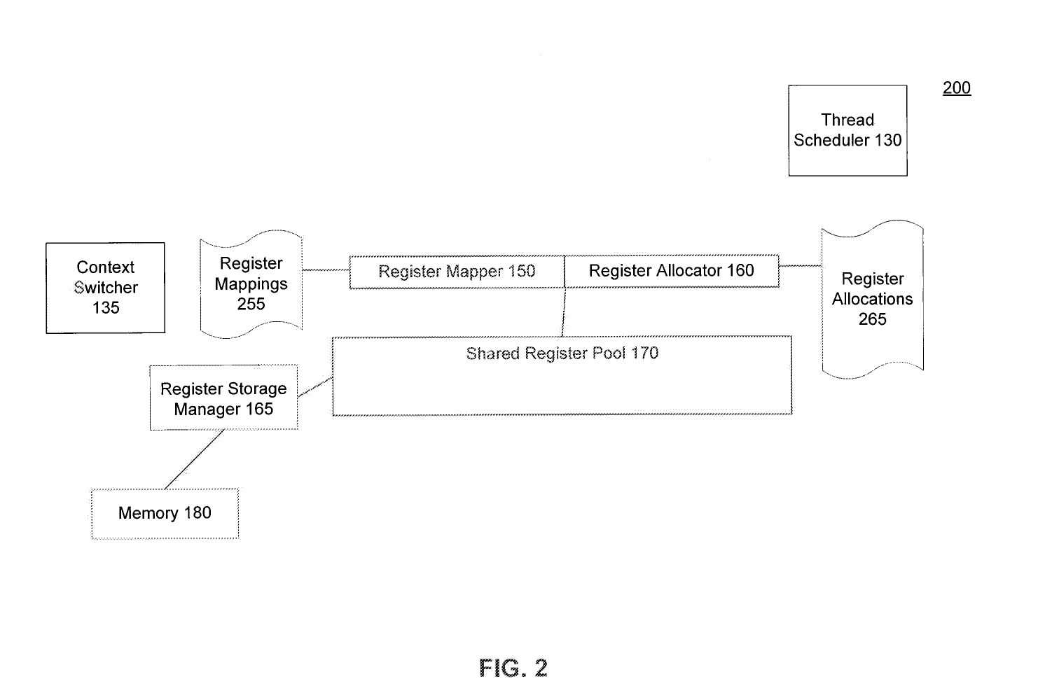

Upon rescheduling of thread 120A, in an example, the existing mappings maintained by register mapper 150 are reused to remap the logical registers required by the continuing execution of instruction 125A by thread 120A. Because, in this example, thread 120B used different allocated physical registers in shared register pool 170, the values in the physical registers allocated to thread 120A were not overwritten while thread 120A was deallocated. This approach is discussed in further detail with the description of FIGS. 2-4 below.

According to an embodiment, FIG. 2 shows a system 200 for allocating and mapping to a shared register pool 170. Embodiments use register storage manager 165 to manage deferred register storing in memory 180 for shared register pool 170. Register mapper 150 uses register mappings 255 to map logical registers to physical registers in shared register pool 170, and register allocator 160 uses register allocations 265 to allocate physical registers in shared register pool 170. System 200 includes context switcher 135 and thread scheduler 130.

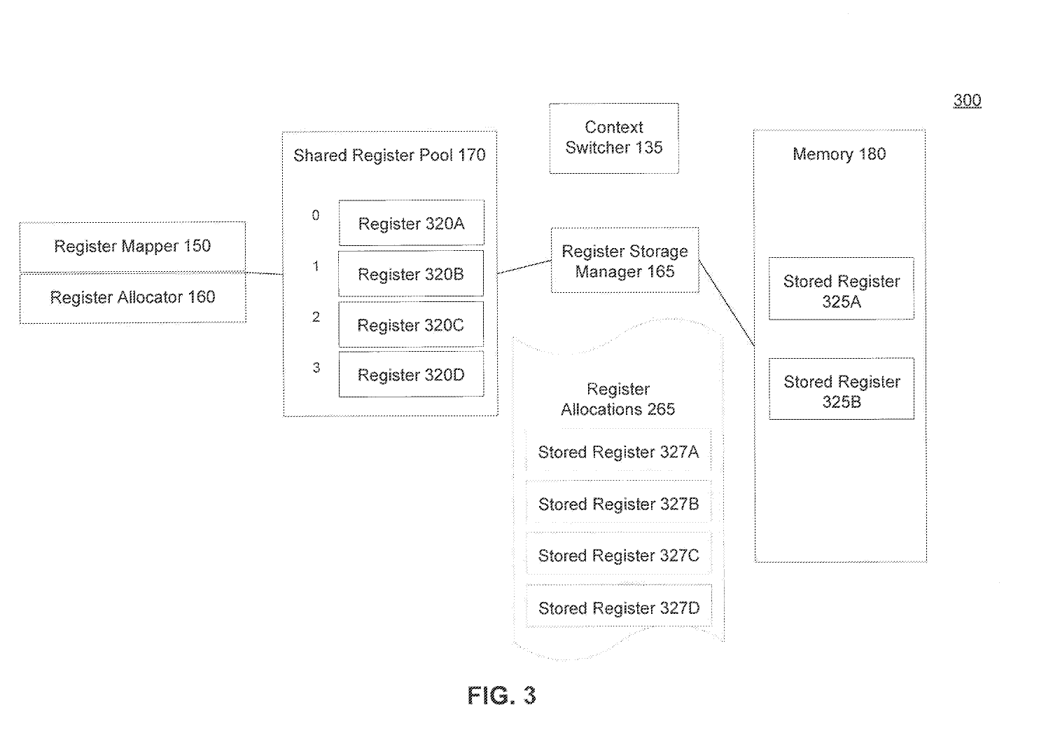

FIG. 3 shows a system 300 having shared register pool 170, memory 180, context switcher 135, register storage manager 165, register mapper 150 and register allocator 160 according to an embodiment. Shared register pool 170 has registers 320A-D and memory 180 has stored registers 325A-B. In this example, to illustrate different concepts, shared register pool has only four registers (320A-D). In typical embodiments, shared register pool 170 has significantly more registers, e.g., more than 64. Register mapper 150 uses register allocations 265 having references to stored register 327A-D.

In an embodiment referencing FIGS. 1-3, thread 120A executed instruction 125A using core 115A. Register allocator 160 allocates registers 320A-B in shared register pool 170 to thread 120A, and stores the allocations in register allocations 265. The logical registers referenced by thread 120A are mapped to allocated physical registers by register 320A-B.

After execution, with reference to core 115A, thread scheduler 130 deschedules thread 120A and schedules thread 120B for execution. Executed by thread 120B, instruction 125B references two logical registers, and thus requires two registers from shared register pool 170. Register allocator 160 allocates registers 320C-D to thread 120B and stores the allocations in register allocations 265. The logical registers referenced by thread 120B are mapped to allocated physical registers 320C-D.

Returning to the descheduling of thread 120A, in this example, upon descheduling, register storage manager 165 does not store the values of registers 320A-B in memory 180. Even after thread 120B is scheduled and context switcher 135 switches the context of core 115A from thread 120A to 120B, the values from thread 120A remain in registers 320A-B. This storage state for registers 320A-B is recorded in register allocations 265 in stored register 327A-B.

Because thread 120B has registers 320C-D allocated, these registers are used for execution of instruction 125B. Upon descheduling of thread 120B, as with thread 120A, the values stored in allocated registers 320C-D remain in register 320C-D and are not stored in memory 180. The status of registers 320C-D with reference to thread 120B is stored in register allocations 265 in stored register 327C-D.

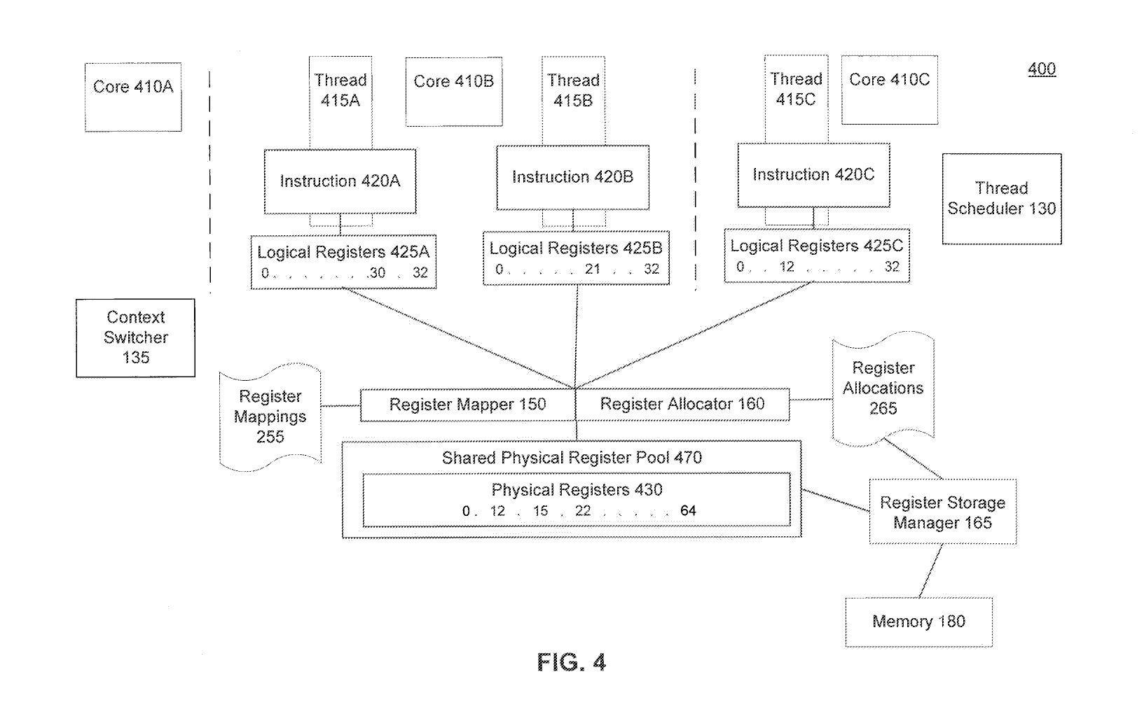

FIG. 4 shows a system 400 for allocating and mapping logical registers 425A-C to physical registers 430 in shared physical register pool 470, according to an embodiment. Instructions 420A-C are executed respectively by threads 415A-C and respectively reference a subset of registers in logical registers 425A-C. It should be noted that different embodiments work within types of multithreading systems.

Core 410B is shown executing threads 415A-B and core 410C is shown executing thread 415C. System 400 includes register mapper 150, register allocator 160, register storage manager 165, context switcher 135, register access controller 490 and thread scheduler 130. Register mapper 150 uses register mappings 255 and register allocator 160 uses register allocations 265.

Thread scheduler 130 is configured to schedule threads 415A-C to be executed by cores 410A-C. Upon the descheduling of one thread and the scheduling of another, context switcher 135 is configured to change the use of shared physical register pool 470 by different threads 415A-C. Embodiments can be implemented with microprocessors having single cores and multiple threads as well as microprocessors with multiple cores and multiple threads per core.

In an example, core 410B alternatively executes instructions 420A-B using respective threads 415A-B. Core 410C executes instruction 420C using thread 415C and other instructions with other threads (not shown).

Upon respective scheduling, instruction 420A is determined to require register 30 in logical registers 425A, instruction 420B is determined to require register 21 in logical registers 425B, and instruction 420C is determined to require register 12 in logical registers 425C. It is important to note that, in the examples described herein, threads of the type discussed herein typically have register requirements beyond the registers shown or discussed. The small amount of registers discussed herein is for convenience and is not intended to be limiting of different embodiments. In this example, each thread 415A-C only requires a single register for the execution of an instruction 420A-C.

In this example, shared physical register pool 470 has physical registers 430 having 64 registers available. Shared physical register pool 470 is typically composed of multiple sets of physical registers. Threads 415A-C, sharing shared physical register pool 470 require, at maximum 96 registers (3×32). As noted above, these numbers are a simplification for the convenience of discussion. Thus, in this example implementation, the three threads 415A-C together require ninety-six (96) registers, and share a shared physical register pool 470 having thirty-two fewer registers than this requirement. Embodiments beneficially fulfill the requirement of example threads 415A-C using the fewer registers available in shared physical register pool 470. Embodiments also used deferred register storage approaches to improve performance in the use of shared physical register pool 470.

An example sequence of actions illustrating deferred saving of registers in shared physical register pool 470 is now discussed. After instructions 420A and 420C are decoded, the logical registers 425A and 425C mapping requirements (respectively 30 and 12) are submitted to register allocator 160. Register allocator 160 checks register allocations 265 and determines that no physical register of physical registers 430 in shared physical register pool 470 has yet been assigned to instructions 420A and 420C, and that physical registers 430 are available in shared physical register pool 470. Physical registers 430 are allocated to instructions 420A and 420C. In this example, physical register 15 in physical registers 430 is allocated to instruction 420A and physical register 12 is allocated to instruction 420C. This allocation is stored in register allocations 265 for future use.

In an nondeferred register storage approach, upon descheduling of thread 415A, the contents of allocated physical register 15 used by instruction 420A in physical registers 430 are stored in memory 180. Upon descheduling of thread 415C, the contents of allocated physical register 12 used by instruction 420A in physical registers 430 are stored in memory 180.

Upon rescheduling thread 415A, the stored contents of allocated physical register 15 used by instruction 420A is retrieved from memory 180 and restored to physical register pool 470. An embodiment can prevent the rescheduling of a thread if a sufficient number of registers are not available in physical registers 430 to handle the thread instruction requirements. In this nondeferred register storage example, the stored contents of register 15 is reloaded into any available register in physical registers 430, and not necessarily back in to physical register 15. This saving and restoring process is typically managed by context switcher 135.

In a deferred register storage approach used by an embodiment, upon descheduling of thread 415A, the contents of allocated physical register 15 used by instruction 420A in physical registers 430 are not stored in memory 180. The contents remain in physical register 15. Similarly, upon descheduling of thread 415C, the contents of allocated physical register 12 used by instruction 420A in physical registers 430 are not stored in memory 180. In an embodiment, register storage manager 165 records the status of physical registers 12 and 15 in register allocations 265.

Upon scheduling of instruction 420B in thread 415B, register allocator 160 queries register allocations 265 and allocates a physical register that is not currently being used by another thread, but also one that doesn't have a value stored within it from a descheduled thread, e.g., physical registers 12 and 15 used by threads 415A and 415C respectively. In this example, register allocator 160 allocated physical register 22 in physical registers 430.

Upon rescheduling of thread 415A, register allocator 160 queries register allocations 265 and determines that the contents of physical register 15 (from the last scheduling of thread 415A) is still available in physical register 15 of physical registers 430. Based on this approach, the execution of thread 415A successfully used a deferred storage approach.

In an example variation of the rescheduling approach discussed above, upon the rescheduling of a new thread (not shown), no physical registers may be available in physical registers 430 that are not currently being used by another thread or don't have a value stored within them from a descheduled thread (e.g., 15, 12 an 22, from respective threads 415A-C).

In this example, the new thread may not be scheduled until registers are available. Thus, even though thread 415A is not currently executing in this example, preserving the value remaining in physical register 15 (and thus improving the overall performance of thread 415A) has priority over the use of register 15 by the new thread instruction.

In a variation of this example, to execute the new thread one of the contents remaining in physical registers 430 (e.g., 12, 15 and 22) will be overwritten. First, one of the registers is selected to be overwritten by the new thread value. As would be appreciated by one having skill in the relevant art(s), given the description herein, the register to overwrite can be selected in a variety of ways, e.g., the priority assigned to threads 415A-C. In this example, the contents of physical registers 430 associated with thread 415A is selected by register allocator 160 to be overwritten, i.e., allocated physical register 15.

Based on the selection by register allocator 160 of physical register 15 to be used by the new thread, register storage manager 165 stores the contents of physical register 15 in memory 180 in a fashion similar to the nondeferred approach described above. Register allocations 265 is updated based on this change.

In an approach similar to the approach described above with respect to the first allocation of a physical register for thread 415B, upon rescheduling of thread 415A, based on the use of physical register 15 by the new thread, register allocator 160 allocates a physical register that is not currently being used by another thread, and also one that doesn't have a value stored within it from a descheduled thread.

### Method

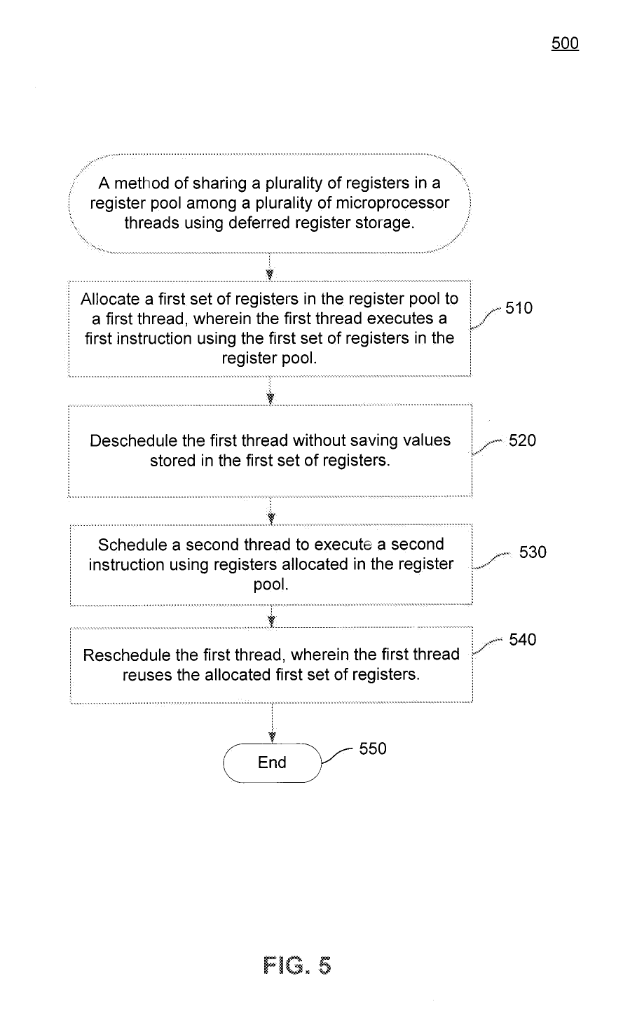

FIG. 5 is a flowchart illustrating a method 500 of sharing a plurality of registers in a shared physical register pool among a plurality of microprocessor threads using deferred register storage, according to an embodiment.

The method begins at stage 510 with an allocation of a first set of registers in the register pool to a first thread, the first thread executing a first instruction using the first set of registers in the register pool. For example, as shown on FIG. 4, instruction 420A executed by thread 415A requires logical register 30 in logical registers 425A. Based on this register requirement, register allocator 160 allocates physical register 15 in physical registers 430 in shared register pool 470. Once stage 510 is completed, the method moves to stage 520.

At stage 520, the first thread is descheduled without saving values stored in the first set of registers. For example, when thread 415A is descheduled, the contents of physical register 15 are not stored by register storage manager 165 in memory 180. Once stage 520 is completed, the method moves to stage 530.

At stage 530, a second thread is scheduled to execute a second instruction using registers allocated in the register pool. For example, instruction 420B executed by thread 415B requires logical register 21 in logical registers 425B. Based on this register requirement, register allocator 160 allocates physical register 12 in physical registers 430 in shared register pool 470. Because, in this example, there are other physical registers in physical registers 430 available, register allocator 160 does not allocate physical register 12 allocated to thread 415A. Once stage 530 is completed, the method moves to stage 540.

At stage 540, the first thread is rescheduled, wherein the first thread reuses the allocated first set of registers. For example, instruction 420A executed by thread 415A is rescheduled and still requires logical register 30 in logical registers 425A. Based on this requirement, register allocator 160 reallocates physical register 15 in physical registers 430 in shared register pool 470. Instruction 420A uses the value stored in physical register 15 and continues to execute using thread 415A. Once stage 540 is completed, the method ends at stage 550.

### Example Microprocessor Embodiment

While various embodiments of the present invention have been described above, it should be understood that they have been presented by way of example, and not limitation. It will be apparent to persons skilled in the relevant computer arts that various changes in form and detail can be made therein without departing from the spirit and scope of the invention. Furthermore, it should be appreciated that the detailed description of the present invention provided herein, and not the summary and abstract sections, is intended to be used to interpret the claims. The summary and abstract sections may set forth one or more but not all exemplary embodiments of the present invention as contemplated by the inventors.

For example, in addition to implementations using hardware (e.g., within or coupled to a Central Processing Unit (“CPU”), microprocessor, microcontroller, digital signal processor, processor core, System on Chip (“SOC”), or any other programmable or electronic device), implementations may also be embodied in software (e.g., computer readable code, program code, instructions and/or data disposed in any form, such as source, object or machine language) disposed, for example, in a computer usable (e.g., readable) medium configured to store the software. Such software can enable, for example, the function, fabrication, modeling, simulation, description, and/or testing of the apparatus and methods described herein. For example, this can be accomplished through the use of general programming languages (e.g., C, C++), GDSII databases, hardware description languages (HDL) including Verilog HDL, VHDL, SystemC Register Transfer Level (RTL) and so on, or other available programs, databases, and/or circuit (i.e., schematic) capture tools. Embodiments can be disposed in any known non-transitory computer usable medium including semiconductor, magnetic disk, optical disk (e.g., CD-ROM, DVD-ROM, etc.,).

It is understood that the apparatus and method embodiments described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present invention should not be limited by any of the above-described exemplary embodiments, but should be defined only in accordance with the following claims and their equivalence. It will be appreciated that embodiments using a combination of hardware and software may be implemented or facilitated by or in cooperation with hardware components enabling the functionality of the various software routines, modules, elements, or instructions, e.g., the components noted below with respect to FIG. 6.

### Example Microprocessor Core

FIG. 6 is a schematic diagram of an exemplary processor core 600 according to an embodiment of the present invention for implementing a shared register pool. Processor core 600 is an exemplary processor intended to be illustrative, and not intended to be limiting. Those skilled in the art would recognize numerous processor implementations for use with an ISA according to embodiments of the present invention.

As shown in FIG. 6, processor core 600 includes an execution unit 602, a fetch unit 604, a floating point unit 606, a load/store unit 608, a memory management unit (MMU) 610, an instruction cache 612, a data cache 614, a bus interface unit 616, a multiply/divide unit (MDU) 620, a co-processor 622, general purpose registers 624, a scratch pad 630, and a core extend unit 635. While processor core 600 is described herein as including several separate components, many of these components are optional components and will not be present in each embodiment of the present invention, or components that may be combined, for example, so that the functionality of two components reside within a single component. Additional components may also be added. Thus, the individual components shown in FIG. 6 are illustrative and not intended to limit the present invention.

Execution unit 602 preferably implements a load-store (RISC) architecture with single-cycle arithmetic logic unit operations (e.g., logical, shift, add, subtract, etc.). Execution unit 602 interfaces with fetch unit 604, floating point unit 606, load/store unit 608, multiple-divide unit 620, co-processor 622, general purpose registers 624, and core extend unit 635.

Fetch unit 604 is responsible for providing instructions to execution unit 602. In one embodiment, fetch unit 604 includes control logic for instruction cache 612, a recoder for recoding compressed format instructions, dynamic branch prediction and an instruction buffer to decouple operation of fetch unit 604 from execution unit 602. Fetch unit 604 interfaces with execution unit 602, memory management unit 610, instruction cache 612, and bus interface unit 616.

Floating point unit 606 interfaces with execution unit 602 and operates on non-integer data. Floating point unit 606 includes floating point registers 618. In one embodiment, floating point registers 618 may be external to floating point unit 606. Floating point registers 618 may be 32-bit or 64-bit registers used for floating point operations performed by floating point unit 606. Typical floating point operations are arithmetic, such as addition and multiplication, and may also include exponential or trigonometric calculations.

Load/store unit 608 is responsible for data loads and stores, and includes data cache control logic. Load/store unit 608 interfaces with data cache 614 and scratch pad 630 and/or a fill buffer (not shown). Load/store unit 608 also interfaces with memory management unit 610 and bus interface unit 616.

Memory management unit 610 translates virtual addresses to physical addresses for memory access. In one embodiment, memory management unit 610 includes a translation lookaside buffer (TLB) and may include a separate instruction TLB and a separate data TLB. Memory management unit 610 interfaces with fetch unit 604 and load/store unit 608.

Instruction cache 612 is an on-chip memory array organized as a multi-way set associative or direct associative cache such as, for example, a 2-way set associative cache, a 4-way set associative cache, an 8-way set associative cache, et cetera. Instruction cache 612 is preferably virtually indexed and physically tagged, thereby allowing virtual-to-physical address translations to occur in parallel with cache accesses. In one embodiment, the tags include a valid bit and optional parity bits in addition to physical address bits. Instruction cache 612 interfaces with fetch unit 604.

Data cache 614 is also an on-chip memory array. Data cache 614 is preferably virtually indexed and physically tagged. In one embodiment, the tags include a valid bit and optional parity bits in addition to physical address bits. Data cache 614 interfaces with load/store unit 608.

Bus interface unit 616 controls external interface signals for processor core 600. In an embodiment, bus interface unit 616 includes a collapsing write buffer used to merge write-through transactions and gather writes from uncached stores.

Multiply/divide unit 620 performs multiply and divide operations for processor core 600. In one embodiment, multiply/divide unit 620 preferably includes a pipelined multiplier, accumulation registers (accumulators) 626, and multiply and divide state machines, as well as all the control logic required to perform, for example, multiply, multiply-add, and divide functions. As shown in FIG. 6, multiply/divide unit 620 interfaces with execution unit 602. Accumulators 626 are used to store results of arithmetic performed by multiply/divide unit 620.

Co-processor 622 performs various overhead functions for processor core 600. In one embodiment, co-processor 622 is responsible for virtual-to-physical address translations, implementing cache protocols, exception handling, operating mode selection, and enabling/disabling interrupt functions. Co-processor 622 interfaces with execution unit 602. Co-processor 622 includes state registers 628 and general memory 638. State registers 628 are generally used to hold variables used by co-processor 622. State registers 628 may also include registers for holding state information generally for processor core 600. For example, state registers 628 may include a status register. General memory 638 may be used to hold temporary values such as coefficients generated during computations. In one embodiment, general memory 638 is in the form of a register file.

General purpose registers 624 are typically 32-bit or 64-bit registers used for scalar integer operations and address calculations. In one embodiment, general purpose registers 624 are a part of execution unit 602. Optionally, one or more additional register file sets, such as shadow register file sets, can be included to minimize content switching overhead, for example, during interrupt and/or exception processing. As described with the descriptions of FIGS. 1-5 above, shared register pool can supplement or replace portions of general purpose registers 624 and floating point registers 618. As also noted above, in an embodiment, shared physical register pool 690 can be composed of SIMD registers.

Scratch pad 630 is a memory that stores or supplies data to load/store unit 608. The one or more specific address regions of a scratch pad may be pre-configured or configured programmatically while processor core 600 is running. An address region is a continuous range of addresses that may be specified, for example, by a base address and a region size. When base address and region size are used, the base address specifies the start of the address region and the region size, for example, is added to the base address to specify the end of the address region. Typically, once an address region is specified for a scratch pad, all data corresponding to the specified address region are retrieved from the scratch pad.

User Defined Instruction (UDI) unit 635 allows processor core 600 to be tailored for specific applications. UDI 634 allows a user to define and add their own instructions that may operate on data stored, for example, in general purpose registers 624. UDI 634 allows users to add new capabilities while maintaining compatibility with industry standard architectures. UDI 634 includes UDI memory 636 that may be used to store user added instructions and variables generated during computation. In one embodiment, UDI memory 636 is in the form of a register file.

### Conclusion

Embodiments described herein relate to deferred register storage in a shared register pool. The summary and abstract sections may set forth one or more but not all exemplary embodiments of the present invention as contemplated by the inventors, and thus, are not intended to limit the present invention and the claims in any way.

The embodiments herein have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A method of sharing a register pool among a plurality of microprocessor threads using deferred register storage, comprising:
allocating a first set of registers in the register pool to a first thread, wherein the first thread executes a first instruction using the first set of registers in the register pool;
descheduling the first thread without saving values stored in the first set of registers;
scheduling a second thread to execute a second instruction using registers allocated in the register pool; and
rescheduling the first thread, wherein the first thread reuses the allocated first set of registers.

2. The method of claim 1, further comprising:
upon descheduling the first thread, saving a value stored in a register of the first set of registers based on a status of the register pool; and
upon rescheduling the first thread, reloading the value into the register of the first set of registers.

3. The method of claim 1, further comprising:
upon descheduling the first thread, saving a value stored in a register of the first set of registers based on a status of the register pool;
allocating a new register from the register pool to the first set of registers; and
upon rescheduling the first thread, reloading the value into the new register of the first set of registers.

4. The method of claim 3, wherein saving the value stored in the register of the first set of registers based on the status of the register pool comprises saving the value stored in the register of the first set of registers based on an allocation of the register to the second thread.

5. The method of claim 4, wherein saving the value stored in the register of the first set of registers based on an allocation of the register to the second thread comprises saving the value stored in the register of the first set of registers based on an allocation of the register to the second thread because no other registers are available in the register pool.

6. The method of claim 1, further comprising:
allocating a second set of registers in the register pool to a second thread, wherein the second thread executes a second instruction using the second set of registers;
upon descheduling the first thread, scheduling the second thread;
descheduling the second thread without saving values stored in the second set of registers; and
rescheduling the second thread, wherein the second thread reuses the values stored in the second set of registers.

7. A method of sharing a plurality of registers in a shared register pool among a plurality of microprocessor threads, comprising:
determining that a first instruction to be executed by a microprocessor in a first microprocessor thread requires a first logical register;
determining that a second instruction to be executed by the microprocessor in a second microprocessor thread requires a second logical register;
allocating a first physical register in the shared register pool to the first microprocessor thread for execution of the first instruction;
mapping the first logical register to the first physical register;
allocating a second physical register in the shared register pool to the second microprocessor thread for execution of the second instruction;
mapping the second logical register to the second physical register;
scheduling the first microprocessor thread and storing a first value in the first physical register;
descheduling the first microprocessor thread without storing the first value in the first physical register;
scheduling the second microprocessor thread and storing a second value in the second physical register; and
rescheduling the first thread, wherein the first thread reuses the first value stored in the first physical register.

8. A system for sharing a plurality of registers in a shared register pool among a plurality of microprocessor threads, comprising:
a thread processing resource configured to execute a first and second microprocessor thread;
a register allocator configured to allocate a first set of registers in the register pool to a first thread, wherein the thread processing resource is configured to execute a first instruction using the first thread and the first set of registers in the register pool; and
a thread scheduler configured to:
deschedule the first thread without saving values stored in the first set of registers,
schedule a second thread to execute a second instruction using registers allocated in the register pool, and
reschedule the first thread, wherein the first thread reuses the allocated first set of registers.

9. The system of claim 8, wherein the first and second instructions are SIMD instructions and the shared register pool are SIMD registers.

10. The system of claim 8, further comprising:
a register storage mapper configured to:
when the first thread is descheduled, save a value stored in a register of the first set of registers based on a status of the register pool, and
when the first thread is rescheduled, reload the value into the register of the first set of registers.

11. The system of claim 8, further comprising:
a register storage mapper configured to:
when the first thread is descheduled, save a value stored in a register of the first set of registers based on a status of the register pool;
allocate a new register from the register pool to the first set of registers for use by the first thread; and
when the first thread is rescheduled, reload the value into the new register of the first set of registers.

12. The system of claim 11, wherein the register storage mapper is configured to save the value stored in the register of the first set of registers based on an allocation of the register to the second thread.

13. The system of claim 11, wherein the register storage mapper is configured to save the value stored in the register of the first set of registers based on an allocation of the register to the second thread because no other registers are available in the register pool.

14. The system of claim 8, wherein:
the register allocator is further configured to allocate a second set of registers in the register pool to the second thread, and
the thread scheduler is configured to:
deschedule the second thread without saving values stored in the second set of registers, and
reschedule the second thread, wherein the second thread reuses the values stored in the second set of registers.

15. A non-transitory computer readable storage medium having encoded thereon computer readable program code for generating a computer processor comprising:
a thread processing resource configured to execute a first and second microprocessor thread;
a register allocator configured to allocate a first set of registers in the register pool to a first thread, wherein the thread processing resource is configured to execute a first instruction using the first thread and the first set of registers in the register pool; and
a thread scheduler configured to:
deschedule the first thread without saving values stored in the first set of registers,
schedule a second thread to execute a second instruction using registers allocated in the register pool, and
reschedule the first thread, wherein the first thread reuses the allocated first set of registers.
